(19) United States
(12) Patent Application Publication
(10) Pub. No.: US 2010/0039197 A1
(43) Pub. Date: Feb. 18, 2010

(54) Inductor structure

(76) Inventor: Chang-Mao Cheng, Taoyuan (TW)

Correspondence Address: BACON & THOMAS, PLLC, 625 SLATERS LANE, FOURTH FLOOR, ALEXANDRIA, VA, 22314-1176, US

(21) Appl. No.: 12/222,538

(22) Filed: Aug. 12, 2008

(51) Int. Cl. H01F 27/02

(52) U.S. Cl. 336/83

(57) ABSTRACT

The invention of one inductor structure comprises one coil, which has one winding coil together with two extended terminals, and plural metal particles with magnetism at least where the winding coil inside plural metal particles is casted and sintered by the powder metallurgy technique and two extended terminals are flat and bended toward 90 degrees in automated punching equipment to become a one-piece chip inductor with costs & fabrication steps dramatically reduced and stable inductance provided.

### BACKGROUND OF THE INVENTION

1. Field of the Invention

This invention of one inductor structure is a one-piece inductor fabricated by way of the powder metallurgy technique where terminals of one coil are flat and bended toward 90 degrees in punching equipment to materialize stable inductance, reduced costs, and automated manufacture & production.

2. Description of the Prior Art

As one important electronic element in electronic products, an inductor with functions of filtering noise within currents, stabilizing currents in circuits, and preventing electromagnetic interference has similar effects like one capacitor to save and release electronic energy in circuits for adjusting stability of currents materialized through storage of electric energy in an electric field (charges) for one capacitor but in a magnetic field for one inductor.

As a result of mutual transformation between electricity and magnetism, a magnetic field will be generated around a conducting wire with currents passing; comparatively, currents will be generated within one coil cutting magnetic lines of force. Like a reel, one inductor has a structure with close conducting wires winded as one coil full of magnetic energy as currents pass and have one force from magnetic energy to resist current changes as currents are reduced. With extensive applications, inductors are used in lots of alliances such as power supply, monitor, switchboard, mother board, scanner, telephone set, and modem.

Under a circumstance of the speedily developed electronic industry, one high precision inductor according to a current tendency in the electronic industry demands low consumption, small volume, high efficiency, low manufacture cost, and fully automated fabrication. However, one conventional inductor made up of a circular magnetic conductor with coils winded inside, as shown in FIG. 1-1, has complicated and artificially fabricated process that causes improper manufacture efficiency, numerous costs, and consumptions.

According the applicant's prior patent applications, U.S. Pat. No. 7,281,315 and U.S. Pat. No. 7,142,084, the inductor is one E/I-type magnetic conductor with a low die-casting density where one E-type magnetic conductor with a winding coil held inside and one I-type magnetic conductor affixed is fabricated in a die-casting die. Because of repeated die-casting, the E/I-type magnetic conductor has a higher density to make the E/I-type magnetic conductor compact tightly. For the purpose of increasing efficiency, lowing costs, and reaching simplified manufacture, the winded coil's two terminals 111 and 111′ needs to be compressed to have flat appearance with a fixture before held inside the E-type magnetic conductor, and then be bended while held inside the magnetic conductor through a die-casting process for the conductor (as shown in FIG. 1-2)

Inductors are categorized to Dual In-line Package inductors and Surface Mount Device inductors (as shown in FIGS. 1-2, 1-3, and 1-4) wherein steps for manufacturing one Surface Mount Device inductor are (as shown in FIG. 6-1): winding (a1) with one coil 11 winded a certain circles to become one winding coil; punching (a2) with two terminals 111, 111′ punched to be flat by one fixture or two terminals 112, 112′ held in copper sleeves 13, 13′ to be compressed for a flat appearance for the case of a small diameter coil; holding (a3) with the winded & punched coil held in one E-type magnetic conductor 10; capsulation (a4) with one I-type magnetic conductor 12 compressed at one side of the E-type magnetic conductor; bending (a5) with terminals 112, 112′ of the flat coil 11 outside the extended magnetic conductors 10, 12 bended to become one Surface Mount Device inductor structure 1;

Drawbacks of one Surface Mount Device inductor: 1. Complicated and artificially processed manufacture steps; 2. Independent fabrication of the E/I-type magnetic conductors leading to more consumption in costs and time and high reject rates of inductors as a result of errors in a die-casting process for both conductors; one merit of one Surface Mount Device inductor: finished inductors can be welded on printed circuit boards with automated machinery.

and steps for manufacturing one Dual In-line Package inductor are (as shown in FIG. 6-2): winding (b1) with one coil 11 winded a certain circles to become one winding coil; holding (b2) with the winding coil held in one E-type magnetic conductor 10; capsulation (b3) with one I-type magnetic conductor 12 compressed at one side of the E-type magnetic conductor to become one Dual In-line Package inductor structure 1;

Drawbacks of one Dual In-line Package inductor: 1. Artificially processed manufacture steps; 2. Independent fabrication of the E/I-type magnetic conductors leading to more consumption in costs and time and high reject rates of inductors as a result of errors in a die-casting process for both conductors; 3. Finished inductors need to be welded on printed circuit boards artificially.

For finished products of either Dual In-line Package inductors or Surface Mount Device inductors, inconsistent dimensions of magnetic conductors in fabrication causing errors of inductance may lead to more unqualified products increasing costs.

Against this background, the inventor considering simplification of one inductor structure imbeds one coil to powdered metal particles by employing the powder metallurgy technique, and delivers the coil for sintering. Next, punched in one punching fixture, the sintered coil's exposed terminals are compressed to be flat and bended to become a one-piece inductor with proper inductance. In virtue of its simple manufacture process via automated steps, the invention promotes the known inductor type and its process.

### SUMMARY OF THE INVENTION

The major purpose of this invention of one inductor structure is to provide one inductor with one winding coil wrapped by way of the powder metallurgy technique is fabricated to become a one-piece inductor.

The minor purpose of this invention of one inductor structure is to punch terminals of the winding coil to form flat appearance and bend them toward 90 degrees by way of automated punching machinery.

Another purpose of this invention of one inductor structure is to make terminals of the winding coil held in hollow copper sleeves for further flat appearance and bending to 90 degrees owing to one coil with different diameters.

Another purpose of this invention of one inductor structure is to offer one inductor, which can be welded on one printed circuit board with an automated method.

The inductor structure comprises one coil, which has one winding coil together with two extended terminals, and plural metal particles with magnetism at least where the winding coil inside plural metal particles is casted and sintered by the powder metallurgy technique and two extended terminals are compressed to flat and bended toward 90 degrees in automatic punching equipment to become a one-piece inductor, which can be welded on one printed circuit board by an automated machinery and has features of dramatically reducing costs & fabrication steps and providing stable inductance. With an illustration of diagrams, the detailed description and technical content related to this invention is displayed as follows:

### DETAILED DESCRIPTION OF THE PREFERRED EMBODIMENTS

Refer to FIG. 2, FIG. 3, FIG. 4-1, FIG. 4-2, FIG. 4-3, and FIG. 4-4 indicating this invention of the inductor structure, which comprises one coil 21 containing one winding coil 210 together with two extended terminals 211 from the coil and one compressed powder 201 formed out of plural magnetic metal particles 20 (not shown in these figures but in FIG. 4-1) in a die-casting process at least to become a one-piece inductor 2;

Winded repeatedly along a center shaft with one conducting wire (for instance, an enamel-insulated wire or a copper wire) circularly or squarely, the coil 21 has both terminals 211 extended toward one side to become the winding coil 210. After winding is completed, the winding coil 210 is held inside one die-casting die 4 with plural metal particles 20 filled for a die-casting process and high-temperature sintering at temperature from 180 to 200 Celsius degrees to become a one-piece inductor 2;

To materialize Surface Mount Device inductors, the plural finished one-piece inductors 2 are held inside one automated punching fixture 3 which has an approximate convex appearance to make casted & sintered inductors' terminals 211, 211′ extended toward one side of the compressed powder 201 straddle the convex fixture and compressed toward the center of the convex fixture to become flat terminals 211, 211′ bended to 90 degrees latter as Surface Mount Device inductors 2 by way of functions of punch pins 30, 30′ on both sides. For the sake of employ this invention of the inductor for embodiment of the Dual In-line Package case, the coil 21 repeatedly winded as the winding coil 210 can be held inside a die-casting die 4 with plural metal particles 20 filled for a die-casting process and heated to temperatures from 180 to 200 Celsius degrees for high-temperature sintering to fabricate the winding coil 210 with terminals 211, 211″ extended on one side of the compressed powder 201 as one Dual In-line Package inductor.

Refer to FIG. 5-1, FIG. 5-2, and FIG. 5-3 indicating one coil 21 having a diameter with a range from 0.3 mm to 2.0 mm. Completing the die-casting and high-temperature sintering process of the powder metallurgy technique, the repeatedly winded coil 21 with a diameter from 0.3 mm to 0.6 mm has the extended terminals 212, 212′ of its winding coil 210 on the side of the compressed powder 21 held inside one hollow copper sleeves 22, 22′ and straddle the convex surface of the automated punching fixture 3. With punch pins 30, 30′ on both sides, terminals 212, 212′ held in copper sleeves 22, 22′ are compressed toward the center of the convex fixture to become flat terminals 212, 212′ with larger areas for the coil 21 having a diameter from 0.3 mm to 0.6 mm and bended 90 degrees toward both sides as one complete Surface Mount Device inductor 2;

Refer to FIG. 6-3, FIG. 6-4, and FIG. 6-5 indicating a flowchart with respect to manufacture of this invention. To fabricate one Surface Mount Device inductor, the major manufacturing steps include at least: winding (c1) with one coil winded certain circles to be a winding coil; die-casting (c2) to make the winding coil held inside one die-casting die with metal particles filled around and compressed & then sintered under high temperatures to be the finalized compressed powder with two terminals extended outside; compressing & bending (c3) to punch two extended terminals of the winding coil to be flat & bended and eventfully become one inductor;

Another embodiment for the coil with a diameter from 0.3 mm to 0.6 mm has following manufacture steps at least: winding (d1) with one coil winded certain circles to be a winding coil; die-casting (d2) to make the winding coil held inside one die-casting die with metal particles filled around and compressed and then sintered under high temperatures to be the finalized compressed powder with two terminals extended outside; holding (d3) to make both extended terminals of the coil with a diameter from 0.3 mm to 0.6 mm held into copper sleeves; compressing & bending (d4) to compress two extended terminals held in copper sleeves to be flat & bended and eventfully become one inductor;

Another embodiment of materializing one Dual In-line Package inductor has following manufacture steps at least: winding (e1) with one coil winded certain circles to be a winding coil; die-casting (e2) to make the winding coil held inside one die-casting die with metal particles filled around and compressed and then sintered under high temperatures to be the finalized compressed powder with two terminals extended outside as one inductor eventfully.

Because the compressed powder containing metal particles tightly pressed in one die-casting die and covering the winding coil inside has a function of effectively maintaining good inductance, the said manufacture steps for this invention of inductors, either Surface Mount Device or Dual In-line Package, are one simple automated fabrication process, which is able to dramatically reduce costs as well as reject rates of finished products, without artificial intervention;

In addition, compared with this invention, the fabrication of one known magnetic conductor divided to E & I-types separately has manufacture steps that the winding coil held inside one E-type magnetic conductor with its opening end stuck by one I-type magnetic conductor can be fabricated as one Surface Mount Device inductor after bending of terminals of the winding coil. As a result of a complicated and artificial manufacture process and separate fabrication steps for E/I-type magnetic conductors, the generated inductors with variable dimensions lead to errors in inductance and increase of defected products causing high costs.

### BRIEF DESCRIPTION OF THE DRAWINGS

FIG. 1-1 is a schematic diagram of one known inductor.

FIG. 1-2 is a schematic diagram of one known inductor.

FIG. 1-3 is a schematic diagram of one known inductor.

FIG. 1-4 is a schematic diagram of one known inductor.

FIG. 2 is a three-dimensional exploded view for this invention of one inductor structure.

FIG. 3 is a three-dimensional view for this invention of one inductor structure.

FIG. 4-1 is a schematic diagram for die-casting of one winding coil in this invention of one inductor structure.

FIG. 4-2 is a schematic diagram for punching of one winding coil's terminals in this invention of one inductor structure.

FIG. 4-3 is a schematic diagram for one winding coil's terminals in this invention of one inductor structure.

FIG. 4-4 is a schematic diagram for bending of one winding coil's terminals in this invention of one inductor structure.

FIG. 5-1 is a schematic diagram for punching of one winding coil's terminals held inside copper sleeves for this invention of one inductor structure.

FIG. 5-2 is a schematic diagram for one winding coil's terminals in this invention of one inductor structure.

FIG. 5-3 is a schematic diagram for bending of one winding coil's terminals in this invention of one inductor structure.

FIG. 6-1 is a schematic diagram for manufacture steps of one known inductor.

FIG. 6-2 is a schematic diagram for manufacture steps of one known inductor.

FIG. 6-3 is a schematic diagram for manufacture steps of this invention of one inductor structure.

FIG. 6-4 is an embodiment for manufacture steps of this invention of one inductor structure.

FIG. 6-5 is another embodiment for manufacture steps of this invention of one inductor structure.

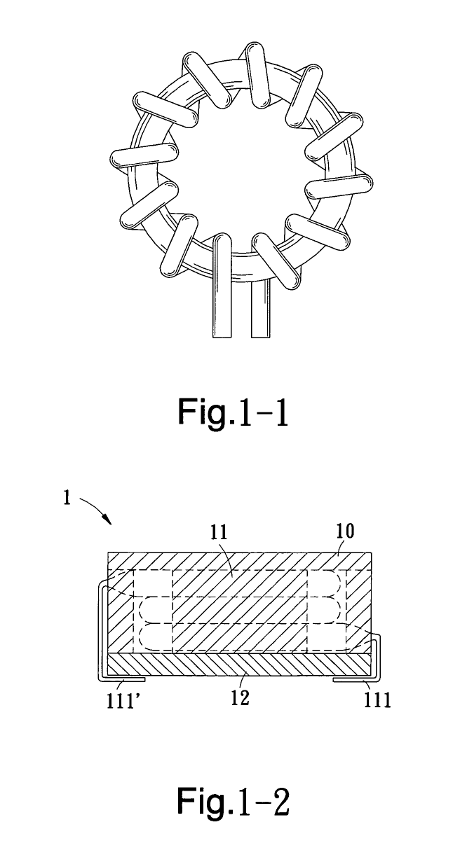

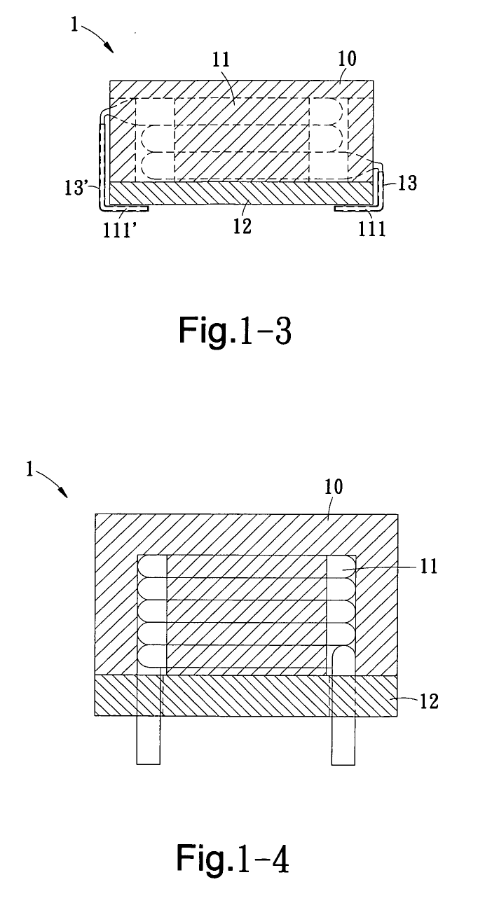

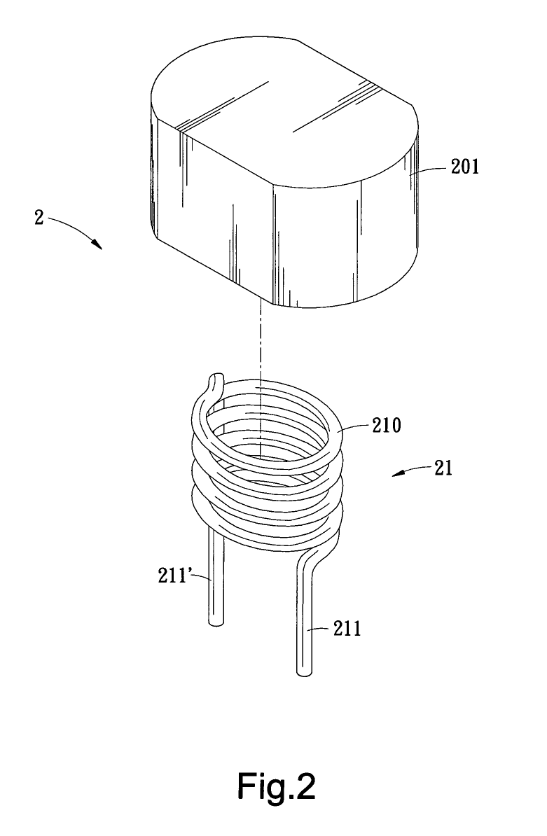

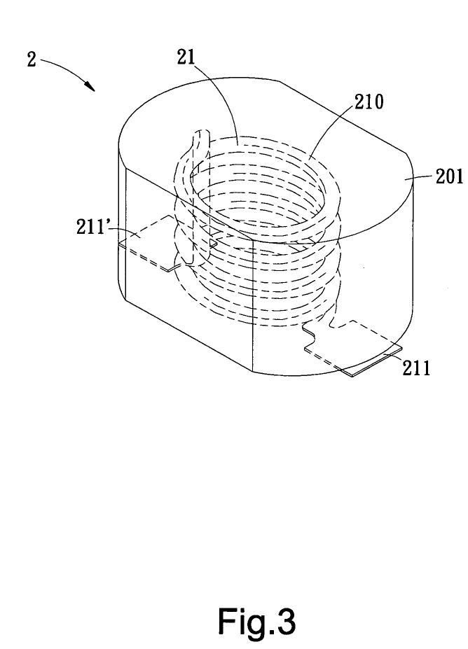

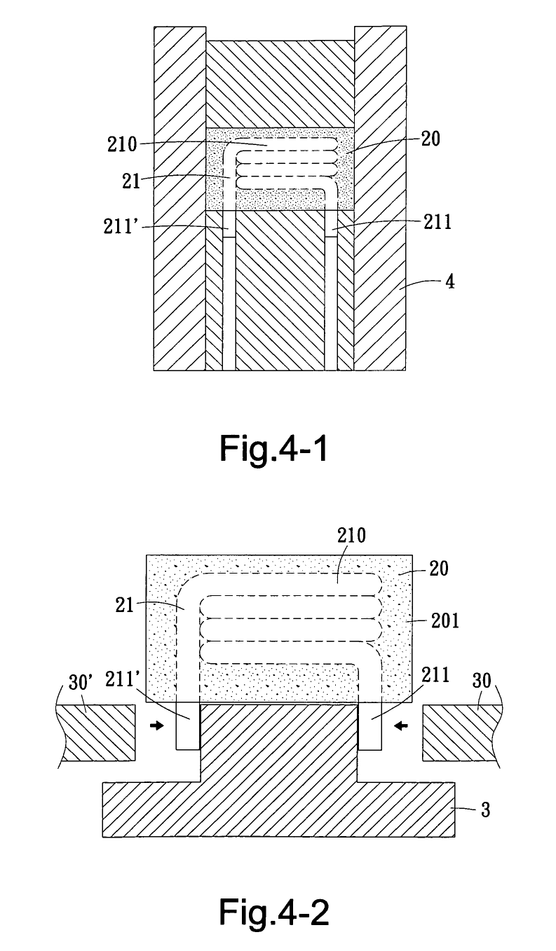

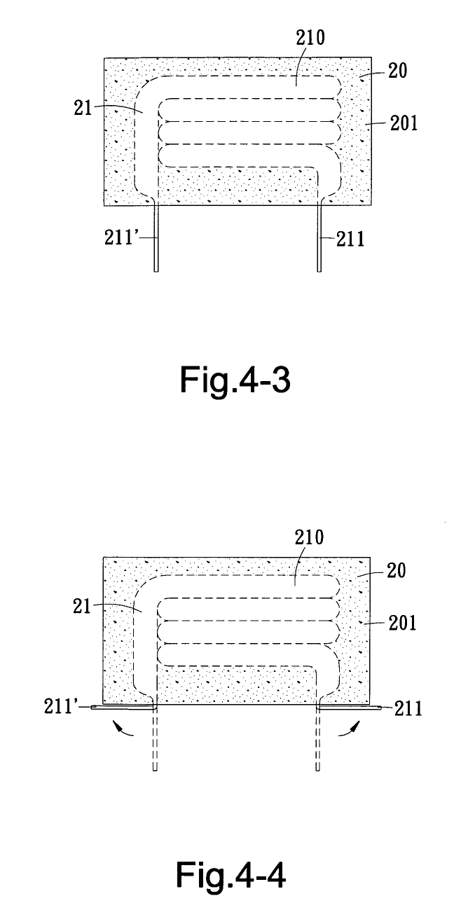

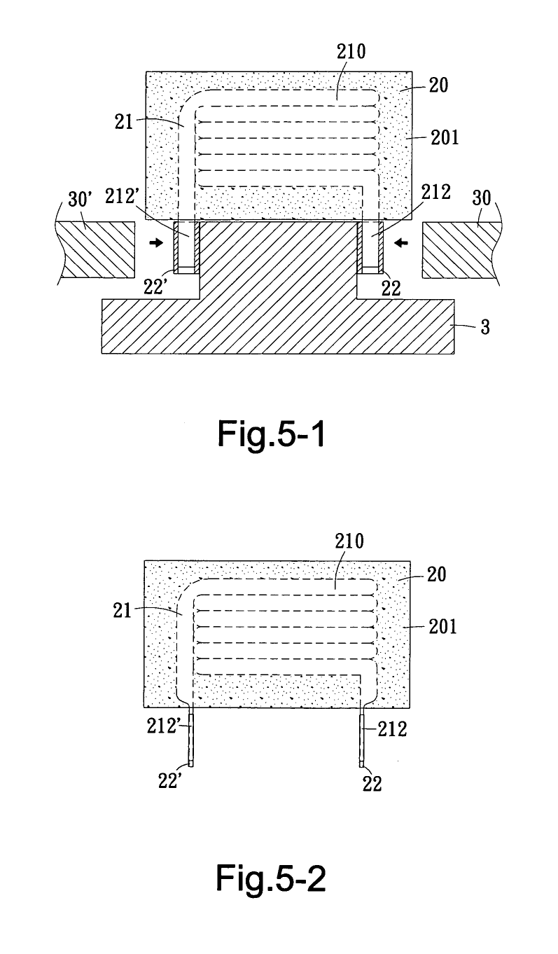

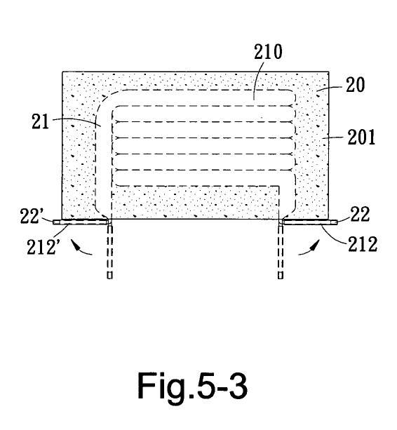

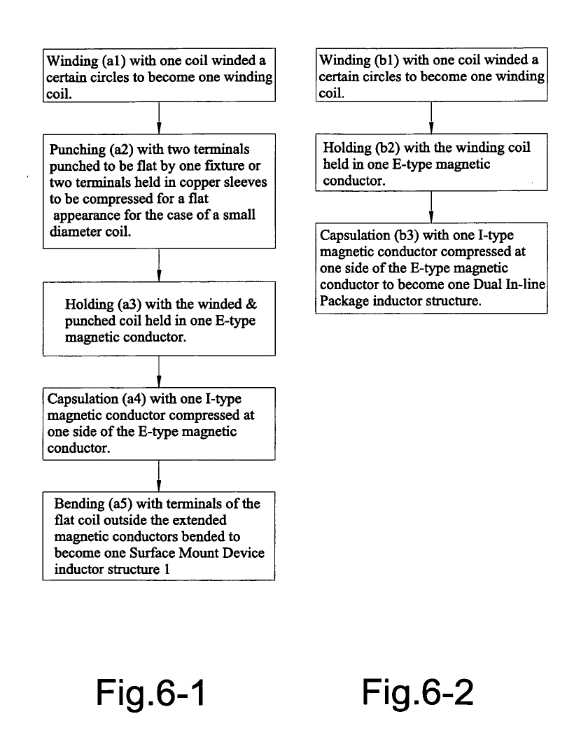

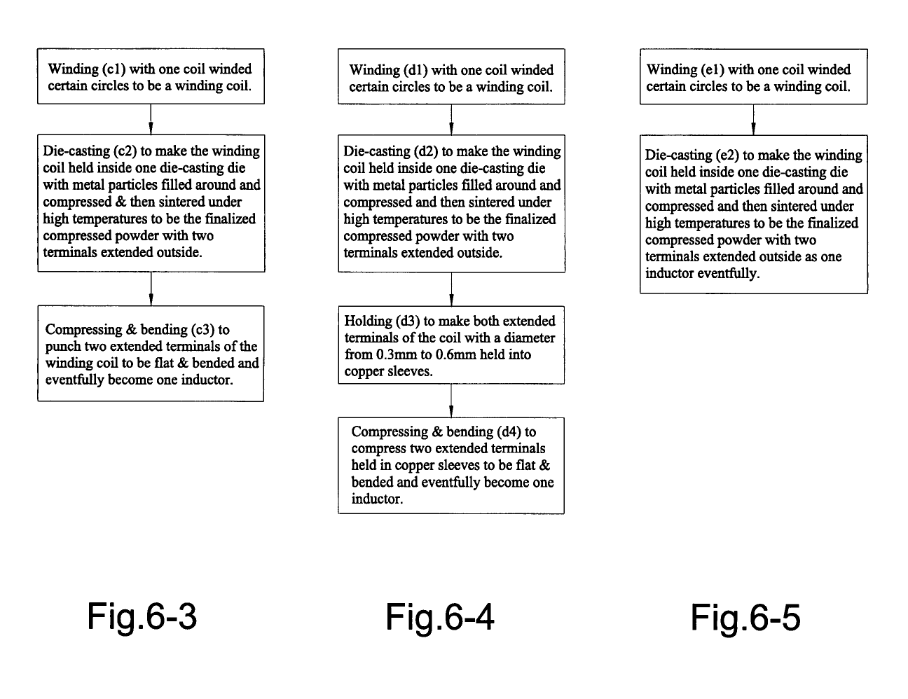

What is claimed is:

1. The inductor structure with one winding coil covered inside through the powder metallurgy technique comprises one coil and plural metal particle, which have the following features:
the repeatedly winded coil is one winding coil with plural terminals extended toward one side and the winded portion covered within plural metal particles via one die-casting process and then high-temperature sintering, and has its extended terminals be flat and then bended toward 90 degrees with one punching fixture as a one-piece Surface Mount Device inductor providing stable inductance and dramatically reducing costs and manufacture steps.

2. The inductor structure according to claim 1, where terminals of the coil can be held inside hollow copper sleeves.

3. The inductor structure according to claim 1, where the metal particles can be mixed with one or plural metals.
